(19) United States
(12) Patent Application Publication
(10) Pub. No.: US 2014/0164394 A1
(43) Pub. Date: Jun. 12, 2014

(54) SYSTEM AND METHOD FOR SERVING ELECTRONIC CONTENT

(71) Applicant: LinkedIn Corporation, Mountain View, CA (US)

(72) Inventors: Sohil C. Maru, Santa Clara, CA (US); Kai Wei, Belmont, CA (US); Sanjay S. Dubey, Fremont, CA (US); Maria E. Jabon, Palo Alto, CA (US)

(73) Assignee: LinkedIn Corporation, Mountain View, CA (US)

(21) Appl. No.: 14/011,195

(22) Filed: Aug. 27, 2013

Related U.S. Application Data
(63) Continuation-in-part of application No. 13/711,499, filed on Dec. 11, 2012.

(51) Int. Cl. G06F 17/30

(52) U.S. Cl. CPC G06F 17/30386
USPC 707/748; 707/758; 707/754

(57) ABSTRACT

A system and methods are provided for serving content in response to content queries or requests. When a request is received, for content to be presented to a specified user, candidate content items are identified, possibly based on matches between attributes of the specified user and attributes of the items' target audiences. For each item, a history indicating the frequency (e.g., total number) and/or recency with which impressions of the candidate item (and/or related items) were previously presented to the specified user is retrieved and used to filter out candidate content items and/or collections of content items that have been already been served to the specified user a threshold number of times. Each remaining item's estimated value is computed, the results are ranked and the top-ranked item(s) are served.

### RELATED APPLICATION

This application is a continuation-in-part of U.S. patent application Ser. No. 13/711,499, entitled “System and Method for Serving Electronic Content,” which was filed Dec. 11, 2012 and is incorporated herein by reference.

### FIELD

This invention relates to computer systems and data processing. In particular, a system and methods are provided for serving electronic content items.

### BACKGROUND

Many types of electronic content are served and presented to users of communication and computing devices such as smart phones, laptop computers, desktop computers, etc. The content may include images, video, audio, text, graphics and so on.

Depending on the application that is operated by the user and to/for which the content is served, such as a web browser, the content may include an entire page or screen of content (e.g., a web page) or just one or more components of a page or screen. Such components may include discrete content items such as advertisements, news articles, status updates of friends or associates of the user, announcements issued by a provider of the application or of a web site visited by the user, etc.

Unfortunately, some existing systems for serving content to users may present a single content item to one user multiple times, to the point that it becomes annoying and the user ignores it and any message it conveys. These types of systems may make no attempt to avoid over-exposure of a given content item.

On the other hand, however, a user may be less likely to act on a particular content item (e.g., by requesting more information, by viewing a larger or better version of the item) until he or she has seen or experienced it multiple times. For this reason, some other systems adhere to an “all-or-none” principle. These systems may stop serving a particular item to a given user after it is served to that user some threshold number of times, but then resume serving the item after some period of time. Thus, for some period of time, the item is completely barred from being served to the user, even if it is the most relevant item for the user and/or would generate the most revenue for the system.

### SUMMARY

In some embodiments of the invention, a system and methods are provided for controlling the serving of electronic content items for presentation to a particular user, such that a single content item is preferably served a sufficient number of times to elicit some user action, but not so often or frequently that the user becomes annoyed with it. The same precaution may be taken regarding multiple content items that have a common trait (e.g., type of content, channel, sponsor) or that are part of a single content collection (e.g., a campaign, a compilation).

The system may comprise a professional or social networking service, a web server, a portal and/or some other type of service that serves content, and the content served from the system may be of one or more types (e.g., advertisements, résumés, status updates, job listings, other announcements). In these embodiments, a user data store is maintained to record details of content served by the system. For example, the system may record, for each user and for each serving of content to the user (or for presentation to the user), which content item was served, when it was served, a sponsor or creator of the item, one or more attributes or properties of the item and/or a content collection (e.g., a campaign) to which the item belongs, etc. Thus, the system is able to track how many times a single content item or items from a set of related items was served or presented to any user, when it was most recently served, etc.

When a request is received for content to serve or present to a user, candidate content items and/or collections of content are identified based on attributes of the user and the content, properties of content collections the system prefers to serve, and/or other criteria. Candidate content is then filtered to eliminate from consideration content items that should not be served because they (or related items) have already been served to this user a threshold or maximum number of times. Such thresholds may apply to discrete periods of time (e.g., one day, one week) or to all time.

Remaining candidate content may be ranked based on estimated values, possibly using probabilities that indicate how likely it is that the user will be interested in or act on what is served (e.g., by clicking on it). One or more items are then selected and served.

### BRIEF DESCRIPTION OF THE DRAWINGS

FIG. 1 is a block diagram depicting a system for serving electronic content, in accordance with some embodiments of the invention.

FIG. 2 is a flow chart illustrating a method of serving electronic content, in accordance with some embodiments of the invention.

FIG. 3 is a diagram of a system for serving electronic content, according to some embodiments of the invention.

### DETAILED DESCRIPTION OF ILLUSTRATIVE EMBODIMENTS

The following description is presented to enable any person skilled in the art to make and use the invention. Various modifications to the disclosed embodiments will be readily apparent to those skilled in the art, and the general principles defined herein may be applied to other embodiments and applications without departing from the scope of the present invention. Thus, the present invention is not intended to be limited to the embodiments shown.

In some embodiments of the invention, a system and methods are provided for serving electronic content. The content may be any type of electronic data formatted for presentation via a web browser or some other application program or user interface. The content may include complete compositions presented individually, such as web pages, documents or videos, or may be components that can be presented as part of a web page or other composition, such as advertisements, job listings, notifications, status updates, news, documents, sports information, images, videos, messages by or concerning members of a professional networking site and so on. In short, electronic content items that are served in embodiments of the invention may include any type of content that can be presented to a user on a communications or computing device.

Although a “content item” may refer to a discrete component or composition of content in some embodiments, in other embodiments it may refer to a collection of components or compositions. An illustrative collection of content items is a “campaign” associated with a product, a service, a person, an organization or other thing. A campaign may encompass multiple graphics, videos, textual compilations or other entities that may, in and of themselves, be deemed “content items.”

Content items of a campaign are not necessarily advertisements, and a site or service that serves or presents the campaign's content items may or may not be compensated for this action. For example, a member of a professional networking site (e.g., which may be an individual or an organization) could publish multiple announcements, status updates, notices, offers, and so on, and these messages could be considered part of a campaign by that member.

As used herein, the term “impression” may refer to any serving or presentation of a content item. Thus, an impression of a given content item may refer to the serving of that content item (e.g., to a web browser, to another application) in response to a request for content (or a content query) and/or the resulting presentation of that content item to a user (e.g., by the web browser or other application).

Embodiments of the invention may be implemented as part of virtually any online system or service that serves data, whether it is a social network service, a professional networking service, a web server, a portal site, a search engine, etc.

In a system described herein that serves electronic content to users and/or for presentation to users, some information about a target user to whom a content item is to be served or presented is received at the system as part of a query or a request for content or may be maintained at the system. For example, when a user or member of a professional networking service connects to the service's site and navigates to a particular page, a web browser or other display engine generates a query to a data server operated by the site, to identify and/or obtain content to present to the user. The content query may include or be accompanied by one or more attributes or characteristics of the user (e.g., gender, age, location, employment status) for use in identifying suitable content.

Similarly, content items that have been stored and that are to be served to users of the system have associated attributes that identify target audiences of the content items and or content collections to which the items belong. For example, an advertisement designed to promote a particular product, a job listing describing a new job opening, or some other item, may be stored at the system with information identifying types of users to whom the item should be presented based on suitable attributes (e.g., gender, age, location, skills, employment status).

Content items other than advertisements may also have associated target audience attributes. For example, target audience attributes of messages published by a member of a professional networking site may specify that the messages be automatically delivered to friends, associates, followers, fans or other members/users associated with the member. This may be done without charge, as part of the professional networking service's normal operations. The member may specify who normally receives the messages, or the site may automatically target them to other members associated with the originating member.

These items (the member's messages) may be considered “organic activities” or “organic content” in that they are created organically—by a member or user of the service as part of their interaction with the site—and may involve professional activity of the originator. Although they are not traditional advertisements, organic activities may be treated similarly as far as having defined target audiences, and a sponsor of an organic activity may be able to pay to have the activity disseminated to users who may not otherwise receive it. Thus, traditional advertisements, organic content items, campaigns and/or other collections of content may have associated attributes or properties that will help the system match content with recipients.

In response to a query or request for content to present to a particular user (e.g., when that user loads a page of the professional networking site), the system searches for appropriate content by comparing known attributes of the user to recorded attributes of the target audiences of the stored content items. One or more appropriate content items are identified and served for presentation to the user.

However, content items considered for serving to the user are filtered in order to remove from consideration items that have been served to the user too often, and possibly related items. For example, in addition to limiting how often specific content items may be served to a user, similar limits may be enforced for content items from one campaign (or other collection of items) or from one sponsor, and/or content items having some other common trait (e.g., type of campaign, delivery channel).

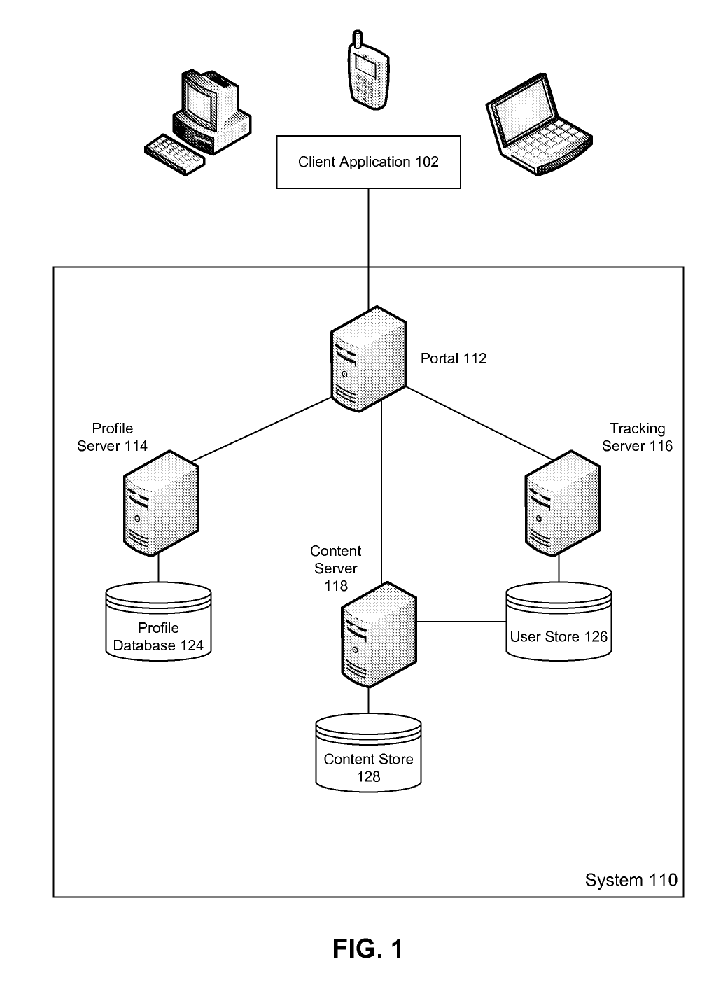

FIG. 1 is a block diagram of a system for serving content, according to some embodiments of the invention. In these embodiments, requests for content are received at portal (or front-end server) 112, which may comprise a web server, application server, data server and/or other hardware or software modules for serving content items in response to requests. System 110 also includes profile server 114, tracking server 116, content server 118, profile database 124, user data store 126 and content store 128.

System 110 may host a professional networking or social networking service, a portal site, a search engine or some other service, which a user accesses via client software application 102. As part of the service, the system serves content for presentation to users via the client application. Client application 102 may be or may comprise a web browser or other application program capable of presenting content items to a user, and may execute on a portable or stationary computing or communication device operated by a user.

Profile server 114 maintains profiles, in profile database 124, of members or users of a service hosted by system 110. A user's profile may reflect any number of attributes or characteristics of the user, including personal (e.g., gender, age range, friends, associates), professional (e.g., job title, job history, employer, industry, skills, endorsements), demographic (e.g., organizations the user is a member of, geographic area of residence), education (e.g., degree(s), university attended), etc.

When a service connection or content request is received at portal 112 from or on behalf of a user, the system retrieves some or all data constituting the user's profile from the profile server. The profile data may be shared throughout system 110 to accompany various actions or communications, such as when content is requested from content server 118, when a record of activity is stored or updated at tracking server 116 and/or user store 126, and so on.

Tracking server 116 monitors and records activity of system 110 (e.g., in user store 126). For example, whenever content is served from portal 112 (e.g., to client software) or displayed for a user, the tracking server records what is served, to whom (e.g., which user), and when. Similarly, the tracking server may also record user actions regarding content items presented to the users (e.g., clicks, follow-on requests), to include identities of the user and the content item acted on, what action was taken, etc.

Content server 118 maintains or is coupled to one or more repositories of content items for serving to users (e.g., content store 128). The content server may also maintain an index of the content items, cached versions of some content items and/or other components. An illustrative means for indexing content items to facilitate their selection and serving to users is described in U.S. patent application Ser. No. 13/972,579, which is entitled “Apparatus and Method for Indexing Electronic Content.” An index, cache or other data structure may identify attributes of stored content items' target audiences, properties of content collections to which the items belong and/or other information.

User store 126 stores, for each user or member of system 110, a record of content items served to the user, or served for presentation to the user, when they were served or presented, and/or other information. User store 126 may therefore be configured to allow the content server (and/or other components of system 110) to quickly determine how many previous impressions of a given content item were presented to a given user, how many impressions of content matching a particular parameter were presented (e.g., content type, content collection, sponsor, channel), when they were presented, how they were presented (e.g., how prominently or where they were presented within a web page or other page of content), and so on.

System 110 may include other components not illustrated in FIG. 1, such as an index of the content maintained by content server 118, an analysis module operating on tracking server 116 (and/or elsewhere) to analyze stored data, and/or other components. Also, in other embodiments of the invention, functionality of a system for serving electronic content as described herein may be distributed differently.

For example, the functionality may be distributed among the illustrated components in an alternative manner, such as by merging or further dividing functions of one or more components, or may be distributed among a different collection of components. Yet further, while implemented as separate hardware components (e.g., computer servers) in FIG. 1, components such as portal 112, profile server 114, tracking server 116 and content server 118 may alternatively be implemented as separate software modules executing on one or more computer servers.

In some embodiments of the invention, a system such as system 110 of FIG. 1 serves electronic content to users or for presentation to users. The system may serve the content directly to a user-operated device executing a suitable client application (e.g., a web browser), for example, or may serve the content to an intermediate entity that then presents the content to the user.

In either scenario, when the system receives a request or query for content to be presented to a user, the system receives (or retrieves) an identity and/or a set of attributes of the user for use in selecting appropriate content. For example, the user may first login to system 110 (e.g., via portal or front-end server 112) before requests are issued for content for the user. In this case, the requests identify the user by name, user identifier or some other indicia understood by the system.

As one alternative, a token may be stored on the user's communication device or computing device and may be delivered to the system with a content request or query. Such a token may identify the user in some way (e.g., with a user identifier assigned by or known to system 110). As another alternative, when a request or query for content for presentation to the user is received at system 110, it may be accompanied by a set of attributes of the user (e.g., age range, gender, location).

In some embodiments of the invention, a system for serving content is operated in a manner that attempts to avoid serving the same content item (or content items from one collection) to the same user on such a frequent basis that the user develops a negative opinion of the item (or collection), a subject or theme of the item, and/or a provider or sponsor of the item. In these embodiments, the system serves sponsored content for presentation to users—content that a provider or sponsor pays to have served—and a goal is to have a sponsored content item served often enough to elicit a response from a user, but not so often that the user develops an aversion to it.

In these embodiments, sponsored content includes advertisements, which may be displayed in various locations within a page of content served to a user from system 110. As described above, sponsored content may also include organic activity of a member or user of the system, if the creator or some other entity pays for it to be distributed to users who might not otherwise see it. Organic activity may be displayed in a central location in a page of content and/or in a location in which an advertisement may be displayed.

When a member or user of system 110 sponsors an organic activity (of that member or of another member), a campaign or other content collection may be created, and suitable attributes of a target audience of the activity defined (e.g., CEOs of mid-size companies, software engineers having skills in Java and mobile communications, accountants with more than ten years experience). The activity, content collection and sponsor are all assigned unique identifiers. Other organic activities sponsored by the same sponsor may be placed in the same campaign or a different one (e.g., depending on target audience attributes).

As described above, content items are stored within a repository such as content store 128, and are indexed by a content server such as server 118. Details of serving activity, such as which content item is served to which user at which time, are stored in a repository such as user store 126 and/or elsewhere.

Users' behavior regarding content items served/presented to them is also recorded. A user's behavior may include clicking on a content item, requesting more information regarding a subject of the content item, requesting re-presentation of the item, requesting a similar or related item, and/or other activity that reflects an interest in the content item, a theme or subject of the content item or a provider or sponsor of the item.

Thus, the system maintains historical data regarding how often and when a particular content item was served, to whom it was served, and what action a user that received the content item did in response. For example, if a user acts on a content item, the system may record that action, which content item was acted upon, which impression of the content item resulted in the action (e.g., 1^{st}, 4^{th}, 7^{th}), and/or other details.

The system may not only record what content items were served to a user in response to a particular request, but may also record where/how they were presented to the user. In particular, content items served by the system may be presented at specific locations within pages of content navigated by a user or otherwise displayed to the user. Those locations may be identified in the content requests, in which case the system may note where each item is presented.

Presentation locations may illustratively comprise x/y coordinates or relative positions/orientations within a page, such as “top” (e.g., at the top of the page), “right margin,” “lower left” and so on. The coordinates, general locations, ratings of the locations (e.g., indicating their relative values or desirability) and/or other indicia of the content item locations may be used to determine a prominence with which a content item is presented, the likelihood that a user will see the content item, and/or other factors.

For example, a content item presented in a large, rectangular, banner-type slot at the top of a page is more prominent and therefore more likely to be observed and viewed by a user (and can be more easily acted on) than another content item presented in a small, square slot at the lower right-hand margin of the page, or an item positioned such that the user must scroll the display before it will be seen. As will be discussed below, the prominence with which a content item is presented to a user may be considered when determining whether the user is likely to act upon the content item (e.g., by clicking on it) or whether the user may be becoming fatigued by the content item. The prominence with which an item is presented may be termed a “weight” because it reflects how much attention it may have received from the viewer.

In some embodiments of the invention, organic content (including sponsored organic content) is presented in a location (or locations) different from locations used to display advertisements. For example, a central portion of a home page, profile page, activity page or other page of the site may be configured to present to the current user a stream of organic content. This streamed organic content may be related to the user (e.g., announcements of new associates or friends, a job listing the user may be qualified for), an associate of the user (e.g., a new skill reported by the associate, a comment or message from the associate), an organization the user follows or agreed to accept updates from (e.g., announcements of a company's new products, news releases from the user's alma mater), etc. Sponsored organic content may be interwoven with nonsponsored organic content, and may or may not be identified as sponsored.

To facilitate monitoring and control of the number of times a particular sponsored content item is served to a single user, details of each serving that are recorded may include information such as: an identifier of the item served, an identifier of the sponsor (which may be an advertiser, a creator of organic activity or some other entity), an originator of the item (which may be different from the sponsor of the item), an identifier of a campaign or other content collection that encompasses the item, the type of content collection (e.g., traditional advertising, job listing, organic activity), the weight with which it was served, a channel in which it was served (e.g., mobile platform, desktop device) and/or others.

In some embodiments of the invention, any or all of the stored details may be used to determine whether or not to refrain from serving particular content to a user. For example, in addition to showing a particular sponsored organic activity no more than X times per day (e.g., X=1), it may be desirable to show no more than Y organic activities having common traits (e.g., from one sponsor or originator, from one collection) per day (e.g., Y=3). Therefore, otherwise suitable content for serving in response to a request may be filtered to eliminate content items based on various criteria or details.

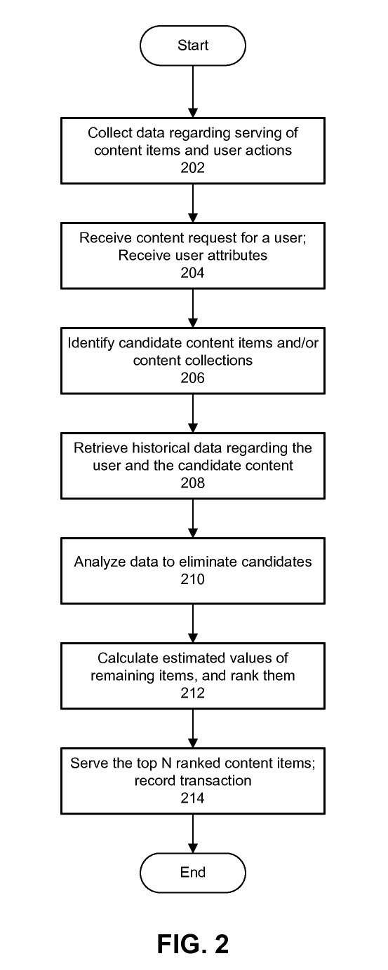

FIG. 2 is a flow chart demonstrating a method of serving electronic content to a user, according to some embodiments of the invention. In this method, multiple content items considered for serving in response to a content request are ranked according to their estimated/expected values or revenues, and one or more items are served.

The estimated values may be calculated based in part on a probability or probabilities that the user or a generic user that will receive the content item(s) would act upon the item(s) (e.g., by clicking on them). Such a probability may be modified based on various factors, such as the number of, and/or recency with which, previous impressions of the content item(s) were served to the user. Illustrative methods of calculating and considering such probabilities are described in U.S. patent application Ser. No. 13/711,499.

In operation 202, data are collected over time regarding the serving of content items to users. As indicated above, each serving of each content item may be recorded, along with a time/date of the serving, a location at which the item was presented (e.g., a position within a page of content), the user to whom the content item was presented, who sponsored the item, the content collection (e.g., campaign) that encompasses the item, the type of content item or collection (e.g., advertisement, sponsored content, job listing), etc. Optionally, any action taken by the user regarding the item may also be recorded.

Data may continue to be collected during execution of the illustrated method and afterward. In particular, the data may be continually updated as content items continue to be served by the content-serving system and as new content items are received and stored for serving.

In operation 204 of the method of FIG. 2, a new content request or query is received, for one or more content items to be presented to a specified user. The system may retrieve or receive a profile or set of attributes associated with the user.

In operation 206, the specified user's attributes and/or other information (e.g., attributes identifying target audiences of stored content items, types of content the system wishes to serve) are used to identify multiple candidate content items that could be served in response to the request and/or content collections from which an item might be selected for serving.

Illustratively, attributes of target audiences of content items available for serving by the system may be compared to attributes of the specified user. Depending on how specific or narrow the attributes are, any number of candidate content items considered suitable for the user may be identified. Similarly, if it is desired to serve a particular type or class of content (e.g., sponsored content, a CPC or cost-per-click advertisement), properties that describe suitable content might be compared to available content items and content collections.

Thus, the candidate content items and/or content collections identified in operation 206 may be identified based on attributes of their target audiences, properties of the items/collections and/or other criteria (e.g., sponsor, originator, type of media).

In operation 208, for some or all of the candidate content, information is retrieved indicating how many times the candidate content items and/or content items having a common trait have previously been served for presentation to the user (e.g., from user store 126 of system 110 of FIG. 1). This information may cover all impressions served or presented to the user, or just impressions that occurred within some period of time (e.g., the last day, the last week, the last 30 days, the last 90 days).

In operation 210, the historical data are analyzed to determine which, if any, of the candidate content identified in operation 206 should be removed from consideration. This analysis may use any of the stored details, along with thresholds or caps on how often or how frequently a particular item or type of item may be served.

As one example, the number of times each content item that is included in the historical data was served to the user is determined (and, possibly, the time span covering the servings) and compared to a cap. Each content item that has already been served the maximum number of times is eliminated from serving in response to the current request.

As another example, the number of times content items sponsored by one entity were served to the user is determined. If this number matches a threshold for content from this sponsor, all sponsored content items from this sponsor are eliminated from consideration. This basis for eliminating content items may also (or instead) be applied based on the creator of the content items, the owner of the content items and/or other similar criteria.

As yet another example, the total number of servings of content items to the user via a particular channel (e.g., mobile) or to a particular device or type of device (e.g., tablet computer, desktop computer, smart phone) may be determined and compared to an applicable cap. Different channels and/or device types may have different caps.

In some embodiments of the invention, different caps or thresholds may be applied for different users, based on one or more user attributes (e.g., age, location, connection type, job, industry). Similarly, different caps may be associated with different time periods. For example, a specific item may be capped at one serving to each user or member per day, and no more than five impressions of content items from the same sponsor may be served to a user/member per week.

In operation 212, estimated values or revenues of the candidate content items are calculated, and the items are ranked according to those values. Content items' estimated values, or revenues, may be calculated differently in different implementations, but generally reflect values the system will receive in return for serving the items.

U.S. patent application Ser. No. 13/711,499 identifies some methods of calculating estimated values. In an illustrative embodiment, however, a simple estimated value may entail comparing the amounts that would be earned by the content-serving system for serving each of the candidate content items, which may equal the bids offered by their sponsors.

In operation 214, after the candidate content items have been ranked according to their estimated values/revenues, the top N items are served in response to the content request, where N may be determined by the number of items requested to be served.

Also, as part of operation 214, or afterward, the transaction (i.e., the serving of the N content items to the user) is recorded. In the currently described embodiment of the invention, each of the N items is recorded as a separate transaction, but this is not required. A transaction may be recorded immediately if the served items are immediately displayed for the user. For example, if the items were served as part of a single page that is displayed in its entirety at one time, then the items are immediately viewable by the user and the transaction can be recorded.

However, in some implementations, one or more of the N items will not be immediately presented to the user, and transactions regarding those items will not be recorded unless and until they are displayed. Illustratively, some or all of the N items may have been selected for placement within a stream or relatively large collection of content that cannot all be displayed at once. In this scenario, the user may need to page down or scroll or take other action (or the content may scroll automatically) before an item is actually displayed. At that time, a control embedded within the item will trigger a notification to the content-serving system that the item has been displayed, and the transaction can be recorded.

When a transaction is recorded for a user, the data stored for that user may be pruned if appropriate. For example, details of content served to the user may only be retained for a specified period of time (e.g., 1 day, 2 days, 1 week), and/or a maximum number of transactions may be stored (e.g., 50, 100). Different amounts of activity may be stored for different users or for different types of users.

In the method of FIG. 2, all impressions of one content item to a given user may be considered equal, regardless of how prominently the impressions were presented. For example, the illustrated method of serving a content item may consider presentation of an impression placed at the top of a page of content to be equally significant as presentation of an impression at the bottom of the page.

In methods of serving a content item according to other embodiments of the invention, however, impressions of a content item may be weighted differently based on the prominence of the impression and/or other factors, such as size, permanence (e.g., how long it is presented), color, behavior, the application or service that presented the page, etc.

In one implementation, presentation of a content item in the most prominent location of a page may be treated as a single impression, while presentations of the content item in less prominent locations may be treated as less than a full impression. For example, a banner location at the top of a page may equate to 1 impression, while an impression at the right-hand edge may be treated as 0.75 impression or 0.5 impression depending on whether it is closer to the top or bottom of the page, and an impression at the bottom of the page (which possibly is seen only if the user scrolls the page down), may be treated as 0.25 impression. In other implementations, weights may be assigned using some other scheme, such as awarding a value of 1 to impressions placed in the least prominent position and awarding to impressions in other positions values that are integer or decimal multiples of 1.

These weights may be applied or employed when assembling historical data, when analyzing the data, and/or when calculating estimated values of content items that are candidates for serving to a user.

For example, when collecting historical data regarding user actions on content item impressions, and/or determining probability modifiers, weights may be applied such that the N^{th} time a particular content item is presented to a particular user only counts as the M^{th} time (M<N), because some of the impressions were not in the most prominent location of a page.

In one implementation, each presentation of a content item may be represented by the weight corresponding to the position in which it was presented (e.g., 2, 1, 0.75, 0.25). In this implementation, multiple presentations may therefore be required before the 1^{st} ordinal impression (or other ordinal impression) is counted.

Similarly, when calculating one candidate content item's estimated value, in order to rank it for possible serving to a specified user, previous presentations of the item to the user may be used to consider the current context, and may also affect the current estimated value. Some or all of those previous impressions may be weighted. For example, a less-prominent display of a particular content item may be less likely to elicit action by the user than a more-prominent display of the same item or a different item.

As another example, if four impressions had been presented previously, all at the top of pages of content, they may count as four full impressions and this may boost the current estimated value of the item (e.g., because the user has some familiarity with the item's message). However, if all four had been presented at the bottom of the pages, at locations having weights of 0.25, then the four impressions together may only count as one impression, and the estimated value may decrease (e.g., because it is assumed that the user may not have yet become aware of the item).

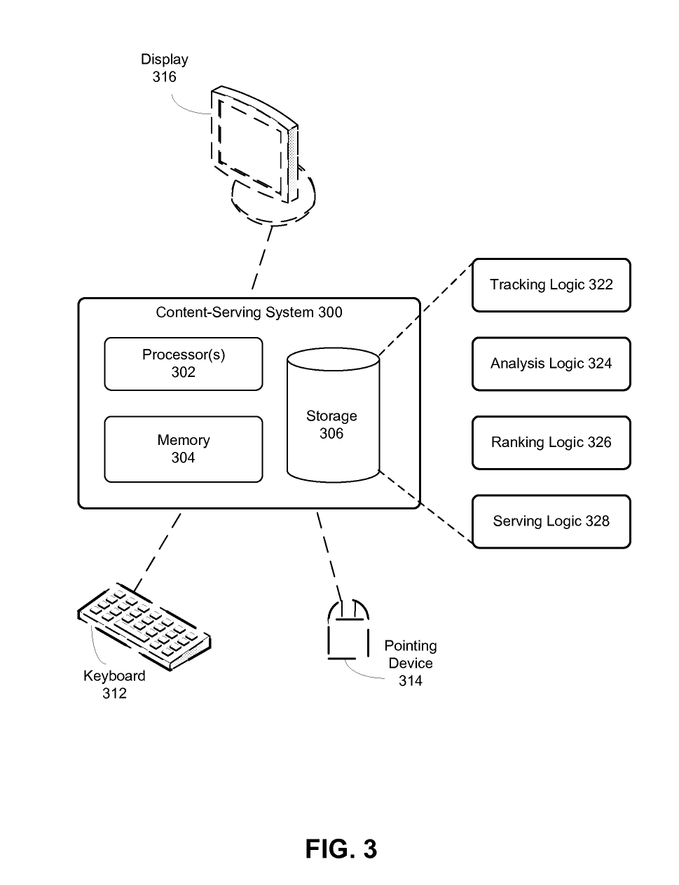

FIG. 3 is a block diagram of a system for serving electronic content, according to some embodiments of the invention.

Content-serving system 300 of FIG. 3 comprises processor(s) 302, memory 304 and storage 306, which may comprise one or more optical and/or magnetic storage components. Content-serving system 300 may be coupled (permanently or transiently) to keyboard 312, pointing device 314 and display 316.

Memory 304 stores bids, estimated values, other data, and/or logic manipulated during operation of system 300.

Storage 306 of the content-serving system stores content for serving to/for users, user data, tracking data and/or other information. Storage 306 also stores logic that may be loaded into memory 304 for execution by processor 302. Such logic includes tracking logic 322, analysis logic 324, ranking logic 326 and serving logic 328. In other embodiments of the invention, any or all of these logic modules or other content may be combined or divided to aggregate or separate their functionality as desired.

Tracking logic 322 comprises processor-executable instructions for tracking content requests received at system 300, tracking the serving of content items to users, tracking user actions on or regarding content items, and/or other behavior. Logic 322 may include, be accompanied by, or used to assemble data reflecting users' activity, content providers' activity and/or other aspects of the system.

Analysis logic 324 comprises processor-executable instructions for analyzing system and/or user activity to eliminate items from being served, based on historical data and/or other actions. The analysis logic may therefore use various criteria (e.g., sponsor ID, content item ID, content collection ID, channel), and associated thresholds, to determine whether candidate content should be excluded from consideration for serving in response to a new request.

Ranking logic 326 comprises processor-executable instructions for ranking content items being considered for serving in response to a content request. Logic 326 may therefore retrieve content item bids, historical values and/or other data, use them to compute content items' estimated values or revenues, and rank the items by the results.

Serving logic 328 comprises processor-executable instructions for handling and responding to content requests. Serving logic may thus process a new request, search for content items suitable for serving in response and serve the selected (e.g., top-ranking) items.

The environment in which some embodiments of the invention are executed may incorporate a general-purpose computer or a special-purpose device such as a hand-held computer or communication device. Details of such devices (e.g., processor, memory, data storage, display) may be omitted for the sake of clarity.

Data structures and code described in this detailed description are typically stored on a non-transitory computer-readable storage medium, which may be any device or medium that can store code and/or data for use by a computer system. Non-transitory computer-readable storage media includes, but is not limited to, volatile memory, non-volatile memory, magnetic and optical storage devices such as disk drives, magnetic tape, CDs (compact discs), DVDs (digital versatile discs or digital video discs), or other non-transitory computer-readable media now known or later developed.

The methods and processes described in the detailed description can be embodied as code and/or data, which can be stored in a non-transitory computer-readable storage medium as described above. When a processor or computer system reads and executes the code and/or data stored on the medium, the processor or computer system performs the methods and processes embodied as data structures and code and stored within the medium.

Furthermore, the methods and processes described below can be included in hardware modules. For example, the hardware modules may include, but are not limited to, application-specific integrated circuit (ASIC) chips, field-programmable gate arrays (FPGAs) and other programmable-logic devices now known or later developed. When the hardware modules are activated, the hardware modules perform the methods and processes included within the hardware modules.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. The scope of the invention is defined by the appended claims, not the preceding disclosure.

What is claimed is:

1. A method of serving electronic content items, the method comprising:
receiving a request for at least one content item for presentation to a first user;
identifying a plurality of content items that match one or more attributes of the first user;
with a processor, eliminating from the plurality of content items one or more of:
a first content item that was previously served to the first user a number of times equal to a first threshold associated with the first content item; and
a second content item having a given trait, wherein content items having the given trait have been served to the first user a number of times equal to a second threshold associated with the given trait; and
serving one or more of the plurality of content items in response to the request.

2. The method of claim 1, further comprising:
ranking the plurality of content items based on their estimated values;
wherein said serving comprises serving the top-ranked one or more content items.

3. The method of claim 1, wherein identifying the plurality of content items comprises:
receiving one or more attributes of the first user; and
searching an index of content items for content items having target audience attributes that match the one or more attributes of the first user.

4. The method of claim 1, wherein:
the first content item is a sponsored organic content item.

5. The method of claim 1, wherein the given trait is an identity of a sponsor of sponsored content items.

6. The method of claim 1, wherein the given trait is an identity of a channel in which the one or more of the plurality of content items are served.

7. The method of claim 1, wherein:
the method is performed by a professional networking site;
the request is received when the first user connects to the professional networking site; and
the requested at least one content item are sponsored organic content items of the professional networking site.

8. The method of claim 7, wherein:
the one or more content items that are served are presented to the first user in a portion of an electronic display in which advertisements are not presented.

9. The method of claim 7, wherein:
the one or more content items that are served are presented to the first user in a portion of an electronic display reserved for sponsored content of the professional networking site.

10. The method of claim 1, further comprising, prior to receiving the request:
serving multiple content items for presentation to multiple users; and
for each serving, recording:
a content item that was served in the serving;
a user to whom the content item was served; and
a time the content item was served.

11. A non-transitory computer-readable medium storing instructions that, when executed by a processor, cause the processor to perform a method of serving electronic content items, the method comprising:
receiving a request for at least one content item for presentation to a first user;
identifying a plurality of content items that match one or more attributes of the first user;
with a processor, eliminating from the plurality of content items one or more of:
a first content item that was previously served to the first user a number of times equal to a first threshold associated with the first content item; and
a second content item having a given trait, wherein content items having the given trait have been served to the first user a number of times equal to a second threshold associated with the given trait; and
serving one or more of the plurality of content items in response to the request.

12. A system for serving electronic content, the system comprising:
a repository of content items for serving in response to requests for content for presentation to users;
a data store comprising, for each of a plurality of users:
for each of the content items that have been previously served for presentation to the user:
first data identifying a number of times the content item was served for presentation to the user; and
second data identifying one or more traits of the content item;
selection logic for identifying a subset of the content items suitable for serving to a first user in response to a request for content to present to the first user; and
filter logic for eliminating from the subset of content items suitable for serving to the first user one or more content items that:
have been served a to the first user a first threshold number of times; or
match a given trait, wherein other content items having the given trait have been served to the first user a second threshold number of times.

13. The system of claim 12, wherein the data store further comprises, for each of the plurality of users and for each of the content items:
third data identifying a recency with which the content item has been served for presentation to the user.

14. The system of claim 12, wherein the one or more traits include a sponsor of an organic content item.

15. The system of claim 12, wherein the one or more traits include a channel in which the content item was served.

16. The system of claim 12, wherein:
the system is operated by a professional networking site in which members, including the first user, generate organic content that is automatically shared with other members; and
at least one content item in the subset of content items suitable for serving to the first user is an organic content item generated by one member and sponsored by a second member.

17. The system of claim 16, wherein the given trait is an identity of a sponsor of one or more organic content items.

18. The system of claim 16, wherein:
one or more content items from the subset of content items are served to the first user in response to the request for content; and
the given trait is a channel of delivery of the one or more content items.
